(19) United States
(12) Patent Application Publication
(10) Pub. No.: US 2025/0377671 A1
(43) Pub. Date: Dec. 11, 2025

(54) SYSTEMS AND METHODS FOR BACK-FLOW PROTECTION USING 3-WAY VALVE CONTROL

(71) Applicant: Toyota Motor Engineering & Manufacturing North America, Inc., Plano, TX (US)

(72) Inventors: Jared M. FARNSWORTH, San Francisco, CA (US); Daniel C. FOLICK, Los Alamitos, CA (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/735,035

(22) Filed: Jun. 5, 2024

(51) Int. Cl. G05D 7/06

(52) U.S. Cl. CPC G05D 7/0635

(57) ABSTRACT

A method, computer program product, and computer system for determining, by a computing device, a first input associated with a valve. A second input associated with the valve may be determined. An amount to adjust the valve to avoid back-flow may be identified based upon, at least in part, the first input associated with the valve and the second input associated with the valve. The valve may be adjusted by the amount to avoid back-flow.

### BACKGROUND

Generally, fuel cell modules may be integrated into customer applications. The fuel cell cooling system radiator may thus be prepared by the customer, and as a result, the cooling control might not have the customer's radiator/piping specifications for control design and calibration. Additionally, such control design and calibration requirements typically cannot be used for other types of uses.

### SUMMARY

In one example implementation, a method, performed by one or more computing devices, may include but is not limited to determining, by a computing device, a first input associated with a valve. A second input associated with the valve may be determined. An amount to adjust the valve to avoid back-flow may be identified based upon, at least in part, the first input associated with the valve and the second input associated with the valve. The valve may be adjusted by the amount to avoid back-flow.

One or more of the following example features may be included. The valve may be a three-way valve. Identifying the amount to adjust the valve to avoid back-flow may be done on-board. Identifying the amount to adjust the valve to avoid back-flow may be done off-board. Adjusting the valve by the amount to avoid back-flow may include dynamically adjusting the valve by the amount to avoid back-flow based upon, at least in part, iterative determinations of the first input associated with the valve and the second input associated with the valve. The first input associated with the valve may be speed. The second input associated with the valve may be temperature.

In another example implementation, a computing system may include one or more processors and one or more memories configured to perform operations that may include but are not limited to determining, by a computing device, a first input associated with a valve. A second input associated with the valve may be determined. An amount to adjust the valve to avoid back-flow may be identified based upon, at least in part, the first input associated with the valve and the second input associated with the valve. The valve may be adjusted by the amount to avoid back-flow.

One or more of the following example features may be included. The valve may be a three-way valve. Identifying the amount to adjust the valve to avoid back-flow may be done on-board. Identifying the amount to adjust the valve to avoid back-flow may be done off-board. Adjusting the valve by the amount to avoid back-flow may include dynamically adjusting the valve by the amount to avoid back-flow based upon, at least in part, iterative determinations of the first input associated with the valve and the second input associated with the valve. The first input associated with the valve may be speed. The second input associated with the valve may be temperature.

In another example implementation, a computer program product may reside on a computer readable storage medium having a plurality of instructions stored thereon which, when executed across one or more processors, may cause at least a portion of the one or more processors to perform operations that may include but are not limited to determining, by a computing device, a first input associated with a valve. A second input associated with the valve may be determined. An amount to adjust the valve to avoid back-flow may be identified based upon, at least in part, the first input associated with the valve and the second input associated with the valve. The valve may be adjusted by the amount to avoid back-flow.

One or more of the following example features may be included. The valve may be a three-way valve. Identifying the amount to adjust the valve to avoid back-flow may be done on-board. Identifying the amount to adjust the valve to avoid back-flow may be done off-board. Adjusting the valve by the amount to avoid back-flow may include dynamically adjusting the valve by the amount to avoid back-flow based upon, at least in part, iterative determinations of the first input associated with the valve and the second input associated with the valve. The first input associated with the valve may be speed. The second input associated with the valve may be temperature.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of a valve process coupled to an example distributed computing network according to one or more example implementations of the disclosure;

FIG. 2 is an example diagrammatic view of a system that may be used by a valve process according to one or more example implementations of the disclosure;

FIG. 3 is an example flowchart of a valve process according to one or more example implementations of the disclosure;

FIG. 4 is an example diagrammatic view of a map creation for a valve process according to one or more example implementations of the disclosure;

FIG. 5 is an example diagrammatic view of systems that may be used by a valve process according to one or more example implementations of the disclosure;

FIG. 6 is an example diagrammatic view of a system and a map creation for a valve process according to one or more example implementations of the disclosure;

FIG. 7 is an example flowchart of a valve process according to one or more example implementations of the disclosure;

FIG. 8 is an example diagrammatic view of a system that may be used by a valve process according to one or more example implementations of the disclosure; and

FIG. 9 is an example diagrammatic view of table for preventing back-flow for use by a valve process according to one or more example implementations of the disclosure.

Like reference symbols in the various drawings may indicate like elements.

### DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains. When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electromagnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer readable program instructions to personalize the electronic circuitry, in order to perform aspects of the present disclosure. Configurable or fixed-functionality logic may be implemented with complementary metal oxide semiconductor (CMOS) logic circuits, transistor-transistor logic (TTL) logic circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision and machine learning applications, including through parallel processing techniques. In one or more examples, the AI accelerator may include hardware logic or devices such as, e.g., a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different, to indicate more constituent signal paths, have a number label, to indicate a number of constituent signal paths, and/or have arrows at one or more ends, to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

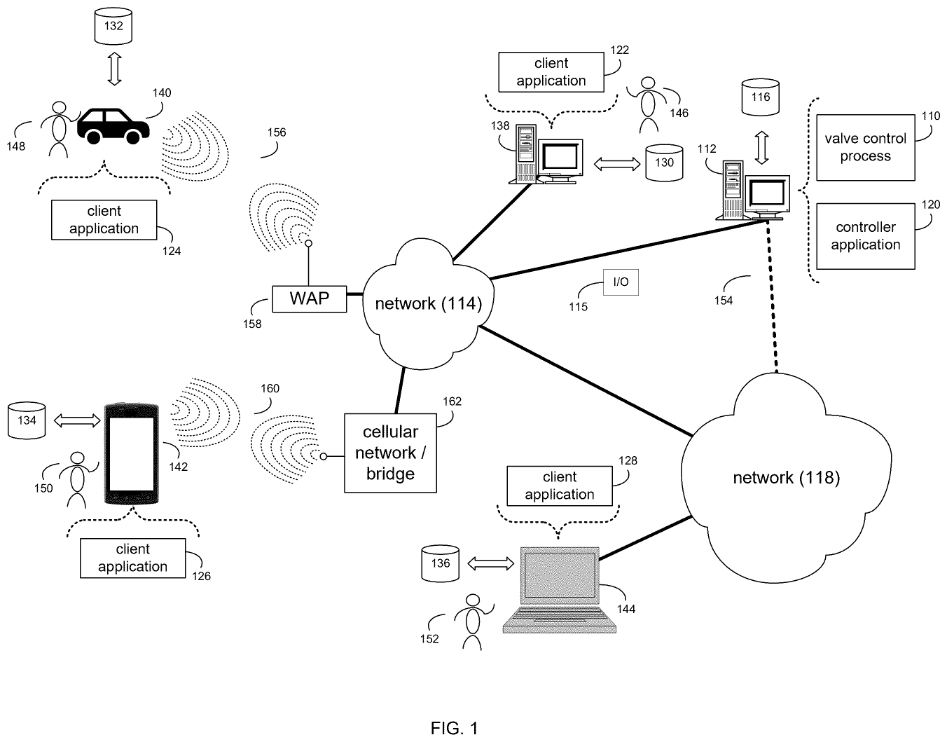

Referring now to the example implementation of FIG. 1, there is shown valve control process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a valve control process, such as valve control process 110 of FIG. 1, may determine, by a computing device, a fuel cell inlet temperature error. A total temperature range that a valve associated with the fuel cell is able to control may be determined. An amount to adjust the valve to change a current temperature of the fuel cell within the total temperature range may be identified based upon, at least in part, the fuel cell inlet temperature error and the total temperate range that the valve associated with the fuel cell is able to control. The valve may be adjusted by the amount to change the current temperature of the fuel cell within the total temperature range.

In some implementations, as will be discussed below in greater detail, a valve control process, such as valve control process 110 of FIG. 1, may determine, by a computing device, a first input associated with a valve. A second input associated with the valve may be determined. An amount to adjust the valve to avoid back-flow may be identified based upon, at least in part, the first input associated with the valve and the second input associated with the valve. The valve may be adjusted by the amount to avoid back-flow.

In some implementations, the instruction sets and subroutines of valve control process 110, which may be stored on storage device, such as storage device 116, coupled to computer 112, may be executed by one or more processors and one or more memory architectures included within computer 112. In some implementations, storage device 116 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 116 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, valve control process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute a controller application (e.g., controller application 120), examples of which may include, but are not limited to, e.g., a pneumatic controller application, an electric actuator application, a hydraulic actuator application, a temperature controller application, a flow rate controller application, a pressure controller application, a flow resistance controller application, a Programmable Logic Controller (PLC) application, a Proportional-Integral-Derivative (PID) controller application, a smart actuator application, or other application that allows for the controlling and operation of a valve. In some implementations, valve control process 110 and/or controller application 120 may be accessed via one or more of client applications 122, 124, 126, 128. In some implementations, valve control process 110 may be a standalone application, or may be an applet/application/script/extension that may interact with and/or be executed within controller application 120, a component of controller application 120, and/or one or more of client applications 122, 124, 126, 128. In some implementations, controller application 120 may be a standalone application, or may be an applet/application/script/extension that may interact with and/or be executed within valve control process 110, a component of valve control process 110, and/or one or more of client applications 122, 124, 126, 128. In some implementations, one or more of client applications 122, 124, 126, 128 may be a standalone application, or may be an applet/application/script/extension that may interact with and/or be executed within and/or be a component of valve control process 110 and/or controller application 120. Examples of client applications 122, 124, 126, 128 may include, but are not limited to, e.g., a pneumatic controller application, an electric actuator application, a hydraulic actuator application, a temperature controller application, a flow rate controller application, a pressure controller application, a flow resistance controller application, a Programmable Logic Controller (PLC) application, a Proportional-Integral-Derivative (PID) controller application, a smart actuator application, or other application that allows for the controlling and operation of a valve, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to client electronic devices 138, 140, 142, 144, may be executed by one or more processors and one or more memory architectures incorporated into client electronic devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a vehicle's electronic control unit (ECU) (e.g., client electronic device 140, which may encompass some or all of the electronic controls (e.g., microprocessor-controlled units) in a vehicle, managing a wide array of functions, from engine operation and fuel efficiency to handling braking systems (ABS), airbag deployment, infotainment systems, transmission systems, climate control, fuel cell operation, radiator systems, etc.), a smart/data-enabled, cellular phone (e.g., client electronic device 142), a notebook computer (e.g., client electronic device 144), a tablet, a server, a television, a smart television, a smart speaker, an Internet of Things (IoT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, smart speakers, watches, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of valve control process 110 (and vice versa). Accordingly, in some implementations, valve control process 110 may be a purely server-side application, a purely client-side application, or a hybrid server-side/client-side application that is cooperatively executed by one or more of client applications 122, 124, 126, 128 and/or valve control process 110.

In some implementations, one or more of client applications 122, 124, 126, 128 may be configured to effectuate some or all of the functionality of controller application 120 (and vice versa). Accordingly, in some implementations, controller application 120 may be a purely server-side application, a purely client-side application, or a hybrid server-side/client-side application that is cooperatively executed by one or more of client applications 122, 124, 126, 128 and/or controller application 120. As one or more of client applications 122, 124, 126, 128, valve control process 110, and controller application 120, taken singly or in any combination, may effectuate some or all of the same functionality, any description of effectuating such functionality via one or more of client applications 122, 124, 126, 128, valve control process 110, controller application 120, or combination thereof, and any described interaction(s) between one or more of client applications 122, 124, 126, 128, valve control process 110, controller application 120, or combination thereof to effectuate such functionality, should be taken as an example only and not to limit the scope of the disclosure.

In some implementations, one or more of users 146, 148, 150, 152 may access computer 112 and valve control process 110 (e.g., using one or more of client electronic devices 138, 140, 142, 144) directly through network 114 or through network 118. Further, computer 112 may be connected to network 114 through network 118, as illustrated with phantom link line 154. Valve control process 110 may include one or more user interfaces, such as browsers and textual or graphical user interfaces, through which users 146, 148, 150, 152 may access valve control process 110.

In some implementations, the various client electronic devices may be directly or indirectly coupled to network 114 (or network 118). For example, client electronic device 138 is shown directly coupled to network 114 via a hardwired network connection. Further, client electronic device 144 is shown directly coupled to network 118 via a hardwired network connection. Client electronic device 140 is shown wirelessly coupled to network 114 via wireless communication channel 156 established between client electronic device 140 and wireless access point (i.e., WAP 158), which is shown directly coupled to network 114. WAP 158 may be, for example, an IEEE 802.11a, 802.11b, 802.11 g, 802.11n, 802.11ac, Wi-Fi®, RFID, and/or Bluetooth™ (including Bluetooth™ Low Energy) or any device that is capable of establishing wireless communication channel 156 between client electronic device 140 and WAP 158 (e.g., Zigbee, Z-Wave, etc.). Client electronic device 142 is shown wirelessly coupled to network 114 via wireless communication channel 160 established between client electronic device 142 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third party offering software as a service (SaaS), platform as a service (PaaS), and/or infrastructure as a service (IaaS). Computer 112 may be implemented using agile development and operations (DevOps) principles. In some implementations, some or all of computer 112 may be implemented in a multiple-environment architecture. For example, the multiple environments may include one or more production environments, one or more integration environments, one or more development environments, etc.

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

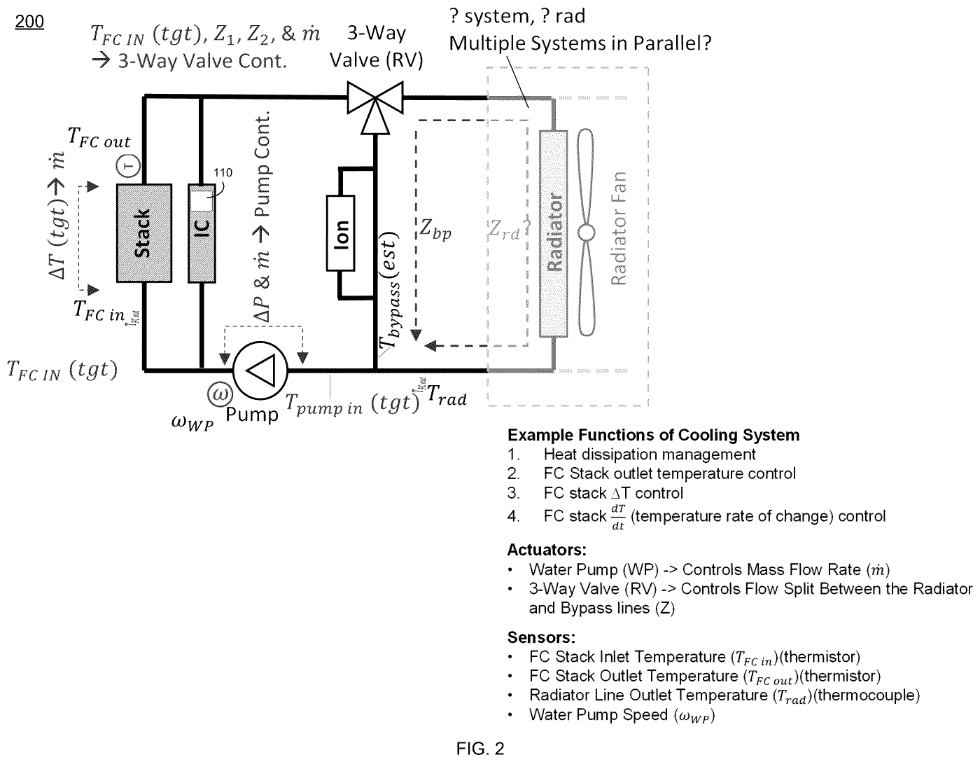

Referring also to the example of FIG. 2, there is shown a diagrammatic view of a system 200 with a three-way valve. Generally, fuel cell (FC) modules may be integrated into customer applications. The fuel cell cooling system radiator may thus be prepared by the customer, and as a result, the cooling control might not have the customer's radiator/piping specifications for control design and calibration. In this example, an Electronic Control Unit (ECU) controls multiple FC modules with cooling systems connected in parallel to a common cooling radiator. The example cooling control method of utilizing real-time State-Estimator(s) is not feasible or practical due to computational load. Another issue is that it may not be known whether there will be multiple coolant systems/loops connected in parallel, raising the potential for back-flow to occur. The radiator path flow resistance may be unknown, so water pressure (WP) ΔP is unknown. WP speed control is based on estimated WP ΔP. Additionally, such control design and calibration requirements typically cannot be used for other types of uses. Some 3-way valve controls may require detailed knowledge of the radiator/piping specifications (e.g., the radiator path flow resistance is unknown (that is, 3-way valve control is based on Z1 & Z2 branch flow resistance). As a result, the 3-way valve position Feed-Forward target will likely be incorrect, causing inaccurate FC inlet temperature control. The result is that the existing WP and 3-way valve control methods cannot be used, as they may require real-time pressure drop, flow resistance, intermediate temperature, and flow rate estimates. This can cause damage to components due to cavitation (WP) and overheat (FC & integrated circuit (IC)), as well as insufficient coolant flow through the Ion exchanger. The WP speed FF target will be incorrect (NG coolant mass flow rate), and thus cannot accurately control the FC outlet temperature.

Some systems may utilize a “Virtual” Bench to characterize Quad FC unit cooling system performance. Such a system uses data for WP and 3-way valve control design and calibration that does not require real-time pressure drop, flow resistance, intermediate temperature, and flow rate estimates. Such systems can also be designed for worst case condition (e.g., three systems operating at maximum WP speed and 3-way valves fully open (100%), and one system operating at a different state, thus implementing the following example control (1) WP Speed MAP: Set WP speed to meet flow rate target in worst case condition (WP speed control); (2) Set minimum WP Speed to prevent back-flow if 3-way valve is stuck open @ 100% (WP speed control); (3) Set maximum 3-way valve position based on WP speed, and prevent back-flow if WP cannot meet target speed (3-way valve control). These types of systems are inefficient, wasting resources, and potentially causing damage to system components due to excessive environmental extremes due to a lack of proper control.

In some instances, the maker of the fuel cell cooling system radiator may know the designed radiator path total pressure drop criteria (max/min), which may be used to characterize system response/sensitivity. Therefore, as will be discussed in greater detail below, the present disclosure describes a partial derivative feed-back based 3-way valve control that does not require a Feed-Forward position estimate. Consequently, the control algorithm may be able to control the FC inlet temperature target without a Feed-Forward based control. This may then be integrated into a radiator control system prepared by the customer, where the customer's radiator/piping specifications for control design and calibration are not available. This may improve efficiencies, conserve resources, and potentially increase the lifespan of system components due to a properly maintained system.

It will be appreciated after reading the present disclosure that the implementations of the valve control process and the back-flow prevention process may be used singly, or in any combination with each other. As such, the description of each process occurring separately should be taken as example only and not to otherwise limit the scope of the present disclosure.

### The Valve Control Process:

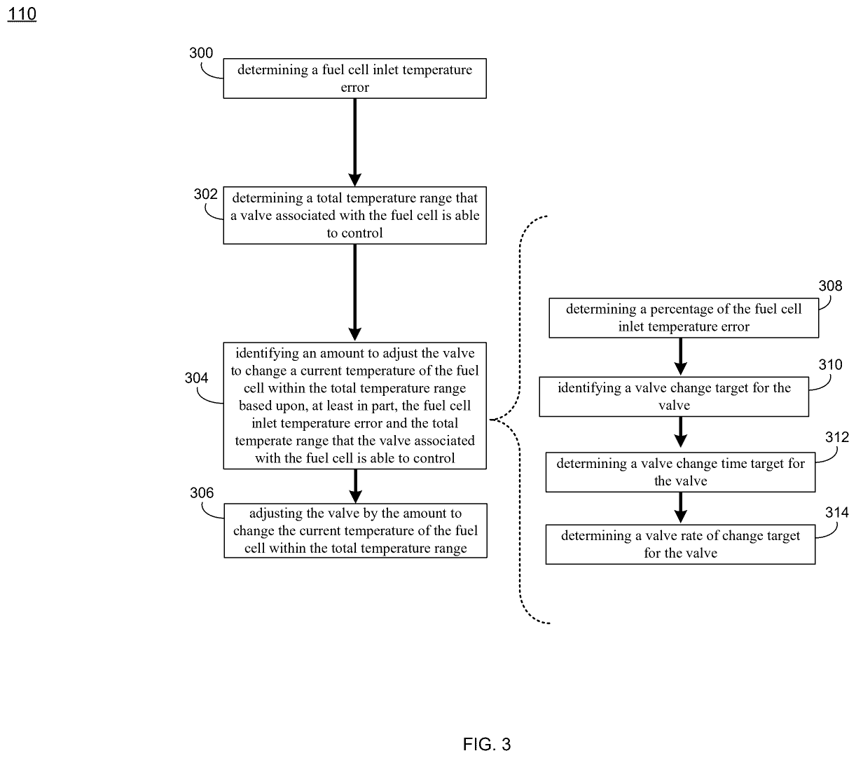

As discussed above and referring also at least to the example implementations of FIGS. 3-6, valve control process 110 may determine 300, by a computing device, a fuel cell inlet temperature error. Valve process 10 may determine 302 a total temperature range that a valve associated with the fuel cell is able to control. Valve process 10 may identify 304 an amount to adjust the valve to change a current temperature of the fuel cell within the total temperature range based upon, at least in part, the fuel cell inlet temperature error and the total temperate range that the valve associated with the fuel cell is able to control. Valve process 10 may adjust 306 the valve by the amount to change the current temperature of the fuel cell within the total temperature range.

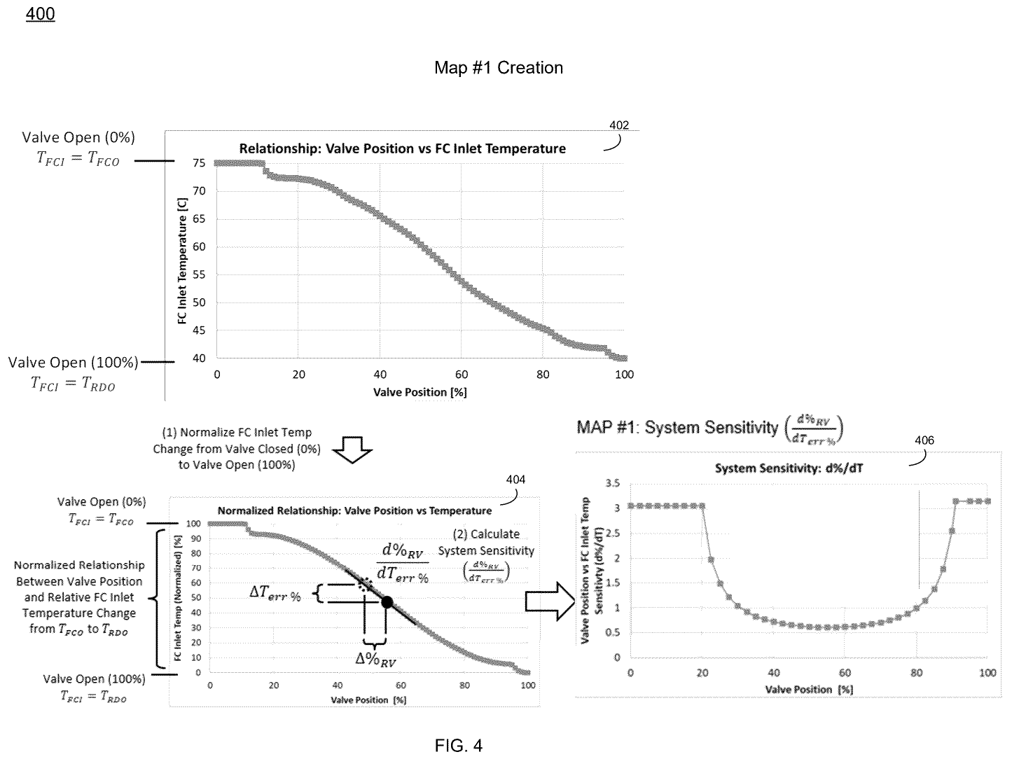

In some implementations, valve control process 110 may determine 300, by a computing device, a fuel cell inlet temperature error. For instance, and referring to eq. 1 below, as well as FIG. 4, valve control process 110 may determine the fuel cell (FC) inlet temperature error.

$$Δ {T}_{FCI} = {T}_{FCI cm} - {T}_{FCI mes} \qquad eq . 1$$

As shown in FIG. 4, there is a process 400 of valve control process 110 for mapping the system sensitivity. In some implementations, valve control process 110 may characterize the relationship between normalized FC inlet temperature change vs 3-way valve position change

$$( \frac{d {\%}_{RV}}{{dT}_{err \%}} ) .$$

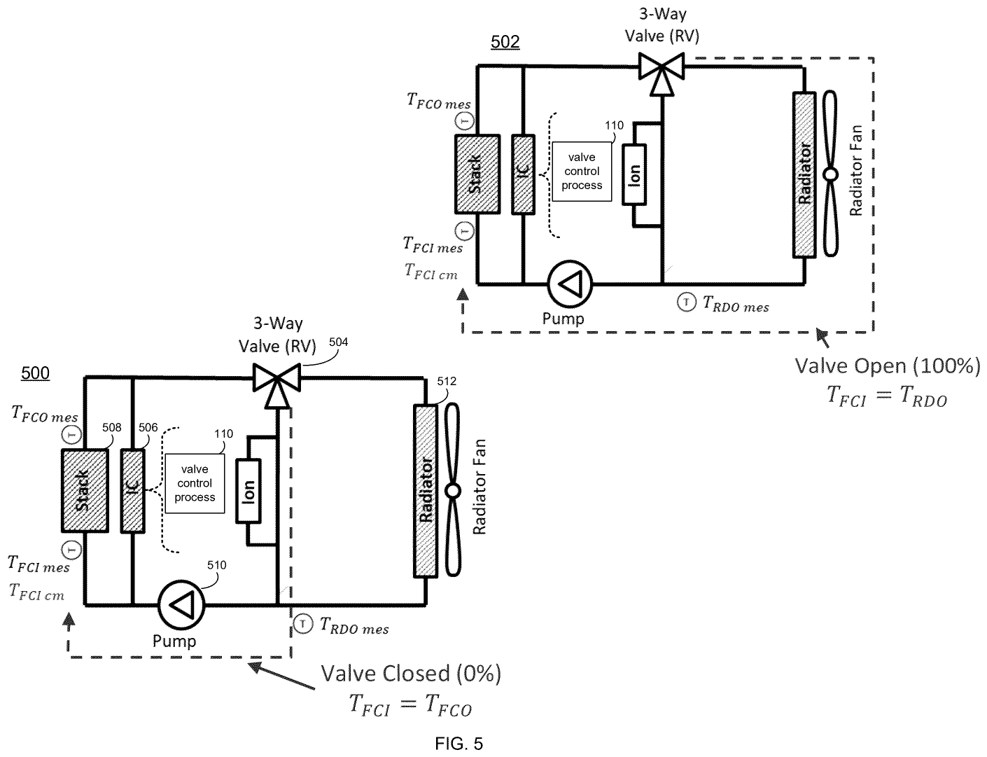

This may involve (1) normalizing the FC inlet temp change from Valve Closed (0%), as shown in FIG. 5, system 500, to Valve Open (100%), as shown in FIG. 5, system 502, and (2) calculating the system sensitivity to normalized FC inlet temp change to valve position change

$$( \frac{d {\%}_{RV}}{{dT}_{err \%}} ) .$$

As can be seen from FIG. 4, example chart 402 shows the relationship between the valve position vs FC inlet temperature, chart 404 shows the normalized relationship between the valve position and relative FC inlet temperature change from Valve Closed (0%) to Valve Open (100%), and chart 406 shows the system sensitivity. It will be appreciated after reading the present disclosure that chart 406 may be 1D or higher dimensional as a function of other parameters as needed to characterize the system. As such, the use of these particular parameters should be taken as example only and not to otherwise limit the scope of the present disclosure.

As shown in FIG. 5, system 500 includes a valve (e.g., valve 504, such as a three-way valve), an integrated circuit (IC) (e.g., IC 506) used by valve control process 110, a stack (e.g., stack 508), a pump (e.g., pump 510), and a radiator (e.g., radiator 512) with radiator fan. In some implementations, IC 506 (via valve control process 110) may be responsible for, e.g.: (1) signal processing (e.g., processing signals from sensors monitoring parameters like flow rate, pressure, and temperature, which are used for the precise control of 3-way valves in fluid handling systems; (2) control logic to implement the control logic required to operate the 3-way valve, including, e.g., timing, sequencing, and decision-making processes based on input from sensors and/or other control systems; (3) using driver circuits to provide the necessary power control and drive signals to operate any actuators (e.g., electric, pneumatic, or hydraulic) that move the valve between its positions; (4) communication for the 3-way valve(s) integrated into larger systems or requiring remote control to handle communication protocols and data exchange with control systems, PLCs, computer-based control systems, etc.; (5) power management to manage the power supply to the valve and its control system to minimize energy consumption.

In some implementations, stack 508 may include controller application 120, which may include the layers of software responsible for controlling a 3-way valve (via valve control process 110). This may range from low-level firmware in actuators or sensor interfaces up to high-level control logic implemented in a central controller or distributed system. In some implementations, pump 510 may be used to move fluids (liquids or gases) through the system's piping. The pump provides the necessary pressure differential to propel the fluid, ensuring that it reaches its intended destination through the correct path determined by the position of the 3-way valve.

In some implementations, valve 504 may direct fluid from pump 510 to different parts of the system or combine two incoming streams into one outgoing stream towards pump 510. The valve's configuration (e.g., L-port or T-port) and the position (which port is connected to which) determine the flow path. Pump 510 and valve 504 may affect system pressure and flow rates, as the positioning of valve 504 affects these system dynamics by changing flow paths, which can alter pressure drops and flow rates. The pump must be capable of adapting to these changes, either through, e.g., manual adjustment, variable speed drives, or by being specified with sufficient margin. In some implementations, pump 510 and valve 504 may be controlled by the same control system (e.g., via valve control process 110) to coordinate their operation. For example, as discussed below, changing the valve position might require adjusting the pump speed to maintain desired pressure and flow rates.

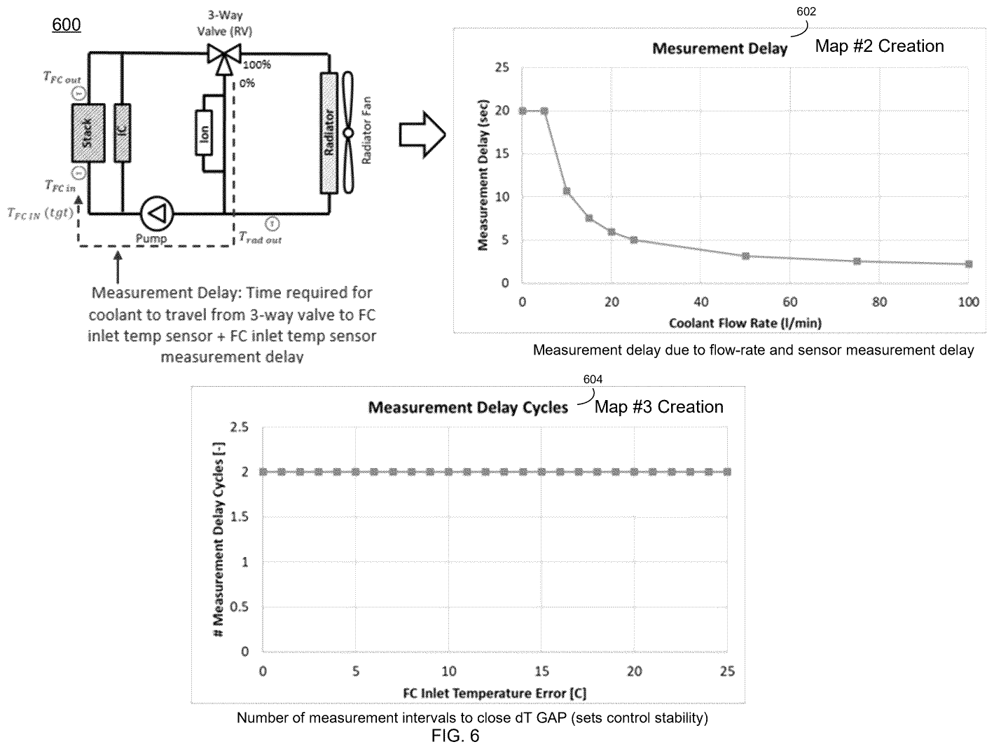

In some implementations, valve process 10 may determine 302 a total temperature range that a valve associated with the fuel cell is able to control. For instance, and referring to eq. 2 below, as well as FIG. 6, system 600 may use valve control process 110 to calculate the time required for a change in coolant mix ratio caused by valve 504 movement to be measured at the FC inlet temperature sensor. In some implementations, determining the total temperature range that the valve associated with the fuel cell is able to control may include a measurement delay to travel from the valve through a plurality of sensors (e.g., —Map #2— includes time needed for coolant to travel from valve 504 to the FC inlet temperature sensor and sensor measurement delay). (e.g., Chart 602 shows the measurement delay due to flow-rate and sensor measurement delay vs coolant flow rate.

$$Δ {T}_{valve} = {T}_{FCO ms} - {T}_{RDO mes} \qquad eq . 2$$

In some implementations, each of the sensors discussed throughout may be placed in various locations depending on desired measurements. For instance, a flow sensor may be placed in the piping before and after major components like pumps and valves to measure the flow rate. Pressure sensors may be installed at critical points in the system, such as before and after the pump and valve 504, to monitor the pressure levels. These sensors can also help detect drops or spikes in pressure that might indicate blockages, leaks, or pump failures. Temperature sensors may be placed at the supply and return lines to measure the effectiveness of heating or cooling. In conjunction with valve 504, these sensors can help regulate the temperature by adjusting the mix of fluids from different temperature sources.

In some implementations, valve process 10 may identify 304 an amount to adjust the valve to change a current temperature of the fuel cell within the total temperature range based upon, at least in part, the fuel cell inlet temperature error and the total temperate range that the valve associated with the fuel cell is able to control, which, in some implementations, identifying the amount to adjust the valve to change the current temperature of the fuel cell within the total temperature range may include determining 308 a percentage of the fuel cell inlet temperature error. For instance, and referring to equation 3 below, valve control process 110 may calculate the percent of FC inlet temperature error to the total temperature range that valve 504 can control. Valve control process 110 may determine the percentage of the fuel cell inlet temperature error.

$$Δ {T}_{err \%} = \frac{Δ {T}_{FCI}}{Δ {T}_{valve}} * 100 [ \% ] \qquad eq . 3$$

In some implementations, identifying the amount to adjust the valve to change the current temperature of the fuel cell within the total temperature range may include identifying 310 a valve change target for the valve. For instance, and referring to equation 4 below, valve control process 110 may calculate the valve change target (e.g., Map #1 in chart 406 in FIG. 4). The valve change target may be described as the amount the valve should be adjusted (e.g., opened/closed) to achieve the desired temperature.

$$Δ {\%}_{RV} = Δ {T}_{err \%} * \frac{d {\%}_{RV}}{{dT}_{err \%}} \to \frac{d {\%}_{RV}}{{dT}_{err \%}} = MAP \#1 ( {\%}_{RV \cdot prev} ) \qquad eq . 4$$

In some implementations, identifying the amount to adjust the valve to change the current temperature of the fuel cell within the total temperature range may include determining 312 a valve change time target for the valve. For instance, refer to equation 5 below, as well as chart 602—Map #2 and chart 604—Map #3 on FIG. 6). As can be seen for chart 604, MAP #3 defines the number of measurement delay cycles to close FC inlet temperature error as a function of absolute FC inlet temperature error (sets control stability).

$${dt}_{tg} = MAP \#2 ( {Q}_{WP} ) * MAP \#3 ( Δ {T}_{FCCI} ) \qquad eq . 5$$

Valve control process 110 may calculate the time required for the change in coolant mix ratio caused by 3-way valve movement to be measured at the FC inlet temperature sensor (includes time needed for coolant to travel from the 3-way valve to the FC inlet temperature sensor and sensor measurement delay).

In some implementations, identifying the amount to adjust the valve to change the current temperature of the fuel cell within the total temperature range may include determining 314 a valve rate of change target for the valve. For instance, and referring to equation 6 below, the amount to open valve 504 to adjust the current temperature of the fuel cell within the total temperature range may be identified by determining the valve rate of change target for the valve.

$$d {\%}_{RV} ( t ) = \frac{Δ {\%}_{RV}}{{dt}_{tg}} \qquad eq . 6$$

In some implementations, the valve may be a three-way valve. For instance, various figures show valve 504 as a three-way valve; however, it will be appreciated that various other types of valves may be used, and with more or less valves without departing from the scope of the present disclosure. As such, the use of a three-way valve should be taken as example only and not to otherwise limit the scope of the present disclosure.

In some implementations, valve process 10 may adjust 306 the valve by the amount to change the current temperature of the fuel cell within the total temperature range. For instance, and referring to equation 7 below, by integrating the FC inlet temperature error, total temperature range that valve 504 can control, the percentage of FC inlet temperature error to the total temperature range that valve 504 can control, the valve change target, the valve change time target, the valve rate of change target, valve control process 110 may open or close valve 504 by the amount necessary to change the current temperature of the fuel cell within the required total temperature range (e.g., open to cool and close to heat). Valve control process 110 may (e.g., via IC 506) instruct valve 504 to open (or close) at a specified amount and at a specified rate.

$${\%}_{RV} = max ( min ( {\%}_{RV \cdot MAX} , \int d {\%}_{RV} ( t ) dt ) , {\%}_{RV \cdot MIN} ) \qquad eq . 7$$

### The Back-Flow Prevention Process:

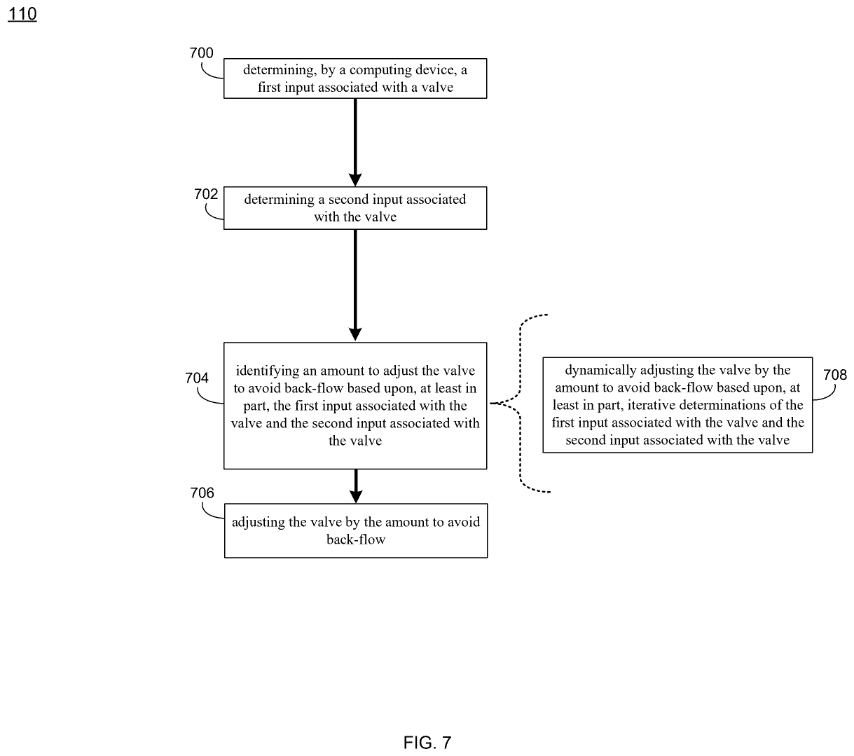

As discussed above and referring also at least to the example implementations of FIGS. 7-9, valve control process 110 may determine 700, by a computing device, a first input associated with a valve. Valve control process 110 may determine 702 a second input associated with the valve. Valve control process 110 may identify 704 an amount to adjust the valve to avoid back-flow based upon, at least in part, the first input associated with the valve and the second input associated with the valve. Valve control process 110 may adjust 706 the valve by the amount to avoid back-flow.

Back-flow (where a liquid is flowing in the opposite direction from its intended path) may occur when the water pump measured speed is less than the water pump commanded speed. This condition may occur during transients and/or water pump issues preventing the water pump speed from meeting the command value. As will be discussed in greater detail below, valve control process 110 may be used to determine and adjust valve positions based on various inputs to prevent back-flow.

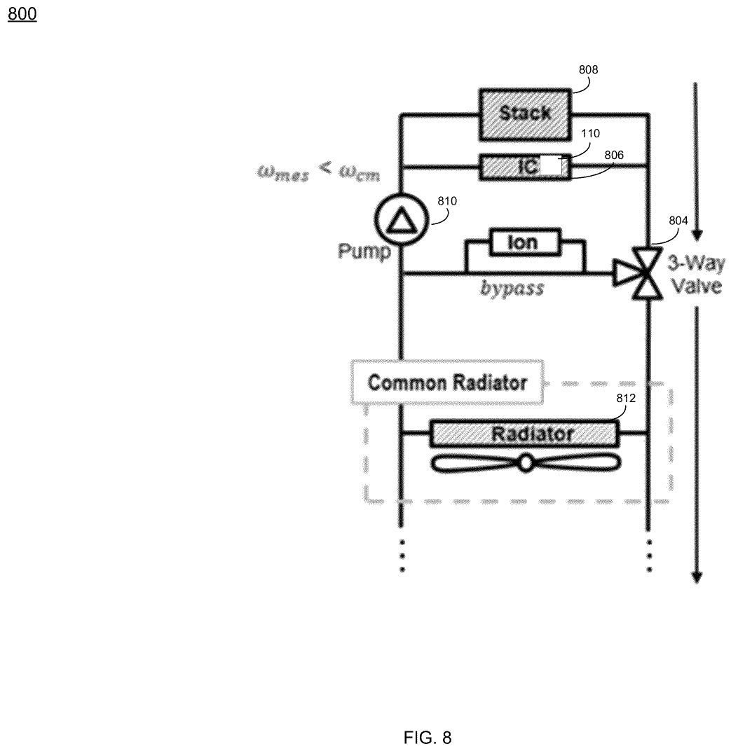

Similar to FIG. 5, FIG. 8 shows a system (e.g., system 800) includes a valve (e.g., valve 804, such as a three-way valve), an integrated circuit (IC) (e.g., IC 806) used by valve control process 110, a stack (e.g., stack 808), a pump (e.g., pump 810), and a radiator (e.g., radiator 812) with radiator fan. In some implementations, IC 806 (via valve control process 110) may be responsible for, e.g.: (1) signal processing (e.g., processing signals from sensors monitoring parameters like flow rate, pressure, and temperature, which are used for the precise control of 3-way valves in fluid handling systems; (2) control logic to implement the control logic required to operate the 3-way valve, including, e.g., timing, sequencing, and decision-making processes based on input from sensors and/or other control systems; (3) using driver circuits to provide the necessary power control and drive signals to operate any actuators (e.g., electric, pneumatic, or hydraulic) that move the valve between its positions; (4) communication for the 3-way valve(s) integrated into larger systems or requiring remote control to handle communication protocols and data exchange with control systems, PLCs, computer-based control systems, etc.; (5) power management to manage the power supply to the valve and its control system to minimize energy consumption.

In some implementations, stack 808 may include controller application 120, which may include the layers of software responsible for controlling a 3-way valve (via valve control process 110). This may range from low-level firmware in actuators or sensor interfaces up to high-level control logic implemented in a central controller or distributed system. In some implementations, pump 810 may be used to move fluids (liquids or gases) through the system's piping. The pump provides the necessary pressure differential to propel the fluid, ensuring that it reaches its intended destination through the correct path determined by the position of the 3-way valve.

In some implementations, valve 804 may direct fluid from pump 810 to different parts of the system or combine two incoming streams into one outgoing stream towards pump 810. The valve's configuration (e.g., L-port or T-port) and the position (which port is connected to which) determine the flow path. Pump 810 and valve 804 may affect system pressure and flow rates, as the positioning of valve 804 affects these system dynamics by changing flow paths, which can alter pressure drops and flow rates. The pump must be capable of adapting to these changes, either through, e.g., manual adjustment, variable speed drives, or by being specified with sufficient margin. In some implementations, pump 810 and valve 804 may be controlled by the same control system (e.g., via valve control process 110) to coordinate their operation. For example, as discussed below, changing the valve position might require adjusting the pump speed to maintain desired temperature and speed.

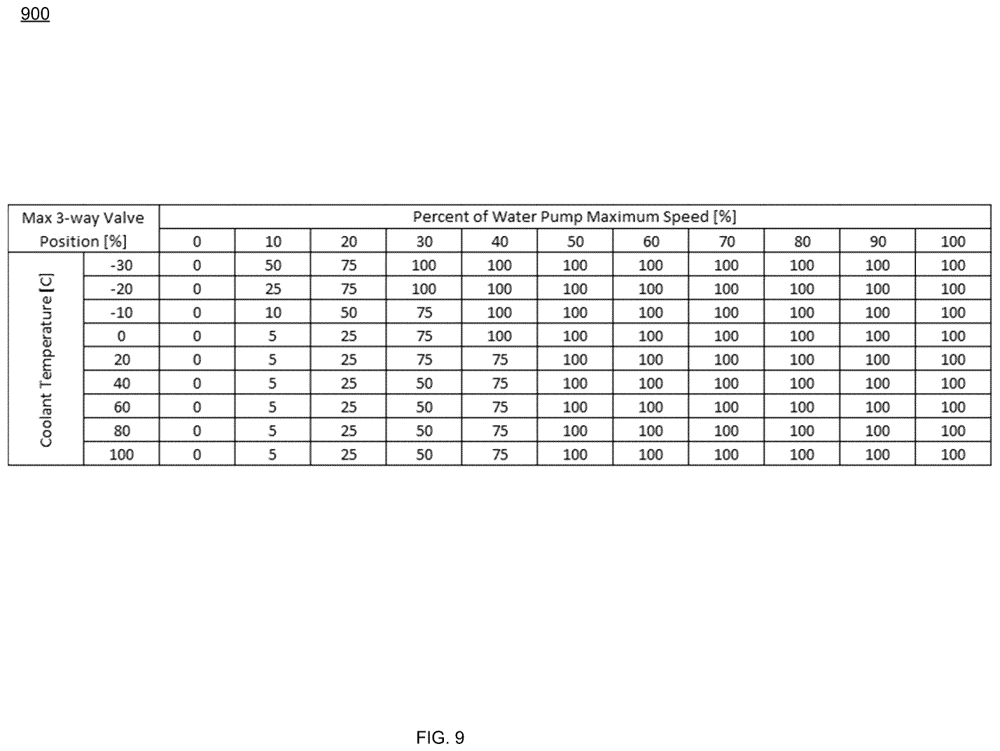

In some implementations, valve control process 110 may determine 700, by a computing device, a first input associated with a valve. For instance, in some implementations, the first input associated with the valve may be speed. Similarly, in some implementations, valve control process 110 may determine 702 a second input associated with the valve, and in some implementations, the second input associated with the valve may be temperature. For instance, and referring to the example table 900 of FIG. 9, there is shown a table indicating a mapping of the maximum 3-way valve position v. measured water pump (WP) speed (in Revolutions Per Minute (RPMs)) for coolant temperature.

In some implementations, valve control process 110 may identify 704 an amount to adjust the valve to avoid back-flow based upon, at least in part, the first input associated with the valve and the second input associated with the valve. For instance, similar to the discussion above, valve control process 110 may set a maximum three-way valve position versus the fluid pump speed as to prevent back flow. This may be done in a transient condition where valve control process 110 is targeting some acceptable operating point but the fluid just has not reached there yet, valve control process 110 may close (or open) the three-way valve to prevent back-flow and couple together until the speed gets there. In some implementations, there may be a scenario where there is some problem with the water pump (e.g., there is some friction issue), valve control process 110 may keep the three-way valve closed to prevent back-flow. Thus, there is a table (e.g., table 900) says based upon the measured water pumps speed, and in this case coolant temperature, there is a maximum three-way valve position to prevent back-flow, and with the maximum allowed three-way valve position (discussed above), the proper three-way valve position may be identified and set.

In some implementations, identifying the amount to adjust the valve to avoid back-flow may be done on-board (e.g., on-board the Electronic Control Unit or IC, etc. in real-time), and in some implementations, identifying the amount to adjust the valve to avoid back-flow may be done off-board (e.g., using a mapping technique to generate table 900 and then using the table to map the current conditions to the desired outcome). For instance, valve control process 110 may determine the table values in real-time (on-board) or offline (off-board) by using a simulation or evaluation on a bench to generate table 900. In some implementations, a high-fidelity model of the system may be used and run through various states to calculate these values (e.g., equivalent to running on a bench or a CFD simulation). Regarding on-board, valve control process 110 may include a state estimator on-board that is using various sensors to determine such things as the pressure drops, water temperature, etc. that the system is actually experiencing in real-time, and from that, valve control process 110 may calculate what is the minimum three-way valve position based upon the pump's speed and pressure.

Notably, with off-board implementations, there may be significantly less computational requirement, as there is no need for a state estimator, although off-board should be done based off worst case scenarios. Conversely, if done on-board, valve control process 110 may actually use the same calculations with the actual system status inputs to more accurately regulate the valve position.

In some implementations, valve control process 110 may adjust 706 the valve by the amount to avoid back-flow. For instance, similar to the discussion above, valve control process 110 may use the temperature and water pump speed to determine how much to open or close valve 804. Valve control process 110 may (e.g., via IC 806) instruct valve 804 to open (or close) at a specified amount and at a specified rate.

In some implementations, adjusting the valve by the amount to avoid back-flow may include dynamically adjusting 708 the valve by the amount to avoid back-flow based upon, at least in part, iterative determinations of the first input associated with the valve and the second input associated with the valve. For instance, as discussed above regarding on-board analysis, valve control process 110 may include a state estimator on-board that is using various sensors to determine such things as the pressure drops, water temperature, etc. that the system is actually experiencing in real-time, and from that, valve control process 110 may calculate what is the minimum three-way valve position based upon the pump's speed and pressure. These measurements may be taken periodically and pre-determined or random intervals.

In some implementations, the valve may be a three-way valve. For instance, various figures show valve 504 as a three-way valve; however, it will be appreciated that various other types of valves may be used, and with more or less valves without departing from the scope of the present disclosure. As such, the use of a three-way valve should be taken as example only and not to otherwise limit the scope of the present disclosure.

It will be appreciated after reading the present disclosure that system 800 may be used for any similar type of system using multiple inputs to control certain functions. For instance, valve control process 110 may be used with a centrifugal pump (or turbo compressors for an air system, etc.) with a flow rate that varies as a function of pressure to prevent back-flow). For example, there may be two air systems connected or one air system connected to two other systems, where there may be a similar scenario where there is a need to control the back pressure to prevent one system from having operating outside of its target (e.g., wind speed). As such, the use of valve control process 110 for back-flow prevention with radiators and fluids should be taken as example only.

It will be appreciated after reviewing the present disclosure that the valve control process and the back-flow prevention process may be combined and/or share features between them. As such, the discussion of the valve control process and the back-flow prevention process separately should be taken as example only and not to otherwise limit the scope of the present disclosure.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
determining, by a computing device, a first input associated with a valve;
determining a second input associated with the valve;
identifying an amount to adjust the valve to avoid back-flow based upon, at least in part, the first input associated with the valve and the second input associated with the valve; and
adjusting the valve by the amount to avoid back-flow.

2. The computer-implemented method of claim 1, wherein the valve is a three-way valve.

3. The computer-implemented method of claim 1, wherein identifying the amount to adjust the valve to avoid back-flow is done on-board.

4. The computer-implemented method of claim 1, wherein identifying the amount to adjust the valve to avoid back-flow is done off-board.

5. The computer-implemented method of claim 1, wherein adjusting the valve by the amount to avoid back-flow includes dynamically adjusting the valve by the amount to avoid back-flow based upon, at least in part, iterative determinations of the first input associated with the valve and the second input associated with the valve.

6. The computer-implemented method of claim 1, wherein the first input associated with the valve is speed.

7. The computer-implemented method of claim 1, wherein the second input associated with the valve is temperature.

8. A computer program product residing on a computer readable storage medium having a plurality of instructions stored thereon which, when executed across one or more processors, causes at least a portion of the one or more processors to perform operations comprising:
determining a first input associated with a valve;
determining a second input associated with the valve;
identifying an amount to adjust the valve to avoid back-flow based upon, at least in part, the first input associated with the valve and the second input associated with the valve; and
adjusting the valve by the amount to avoid back-flow.

9. The computer program product of claim 8, wherein the valve is a three-way valve.

10. The computer program product of claim 8, wherein identifying the amount to adjust the valve to avoid back-flow is done on-board.

11. The computer program product of claim 8, wherein identifying the amount to adjust the valve to avoid back-flow is done off-board.

12. The computer program product of claim 8, wherein adjusting the valve by the amount to avoid back-flow includes dynamically adjusting the valve by the amount to avoid back-flow based upon, at least in part, iterative determinations of the first input associated with the valve and the second input associated with the valve.

13. The computer program product of claim 8, wherein the first input associated with the valve is speed.

14. The computer program product of claim 8, wherein the second input associated with the valve is temperature.

15. A computing system including one or more processors and one or more memories configured to perform operations comprising:
determining a first input associated with a valve;
determining a second input associated with the valve;
identifying an amount to adjust the valve to avoid back-flow based upon, at least in part, the first input associated with the valve and the second input associated with the valve; and
adjusting the valve by the amount to avoid back-flow.

16. The computing system of claim 15, wherein identifying the amount to adjust the valve to avoid back-flow is done on-board.

17. The computing system of claim 15, wherein identifying the amount to adjust the valve to avoid back-flow is done off-board.

18. The computing system of claim 15, wherein adjusting the valve by the amount to avoid back-flow includes dynamically adjusting the valve by the amount to avoid back-flow based upon, at least in part, iterative determinations of the first input associated with the valve and the second input associated with the valve.

19. The computing system of claim 15, wherein the first input associated with the valve is speed.

20. The computing system of claim 15, wherein the second input associated with the valve is temperature.
